(19) United States
(12) Patent Application Publication
(10) Pub. No.: US 2025/0207611 A1
(43) Pub. Date: Jun. 26, 2025

(54) WIND DUCT WITH SILENCER

(71) Applicant: FUJIFILM Corporation, Tokyo (JP)

(72) Inventors: Tomohiro TAKAHASHI, Ashigarakami-gun (JP); Shogo YAMAZOE, Ashigarakami-gun (JP); Shinya HAKUTA, Ashigarakami-gun (JP)

(73) Assignee: FUJIFILM Corporation, Tokyo (JP)

(21) Appl. No.: 19/081,477

(22) Filed: Mar. 17, 2025

Related U.S. Application Data
(63) Continuation of application No. PCT/JP2023/025728, filed on Jul. 12, 2023.

(30) Foreign Application Priority Data
Sep. 21, 2022 (JP) 2022-150111

(51) Int. Cl. F04D 29/66; G10K 11/162

(52) U.S. Cl. CPC F04D 29/664; G10K 11/162

(57) ABSTRACT

Provided is a wind duct with a silencer that can efficiently reduce sound propagating in the wind duct in a case where wind from a blower is sent through the wind duct.

The wind duct with a silencer includes a wind duct in which wind sent from a blowing source flows and a first silencer and a second silencer that reduce sound propagating in the wind duct through a passive silencing method and that have frequency bands of sound to be reduced different from each other. The first silencer having a lower frequency band of the sound to be reduced is disposed at a position closer to the blowing source, and the second silencer having a higher frequency band of the sound to be reduced is disposed at a position farther away from the blowing source. Among peak frequencies of generated sound in the wind duct caused by blowing in the wind duct, a frequency of a primary silencing peak of the second silencer is equal to or higher than a peak frequency at which an intensity of the generated sound is at its maximum.

### CROSS-REFERENCE TO RELATED APPLICATIONS

This application is a Continuation of PCT International Application No. PCT/JP2023/025728 filed on Jul. 12, 2023, which claims priority under 35 U.S.C. § 119 (a) to Japanese Patent Application No. 2022-150111 filed on Sep. 21, 2022. The above applications are hereby expressly incorporated by reference, in their entirety, into the present application.

### BACKGROUND OF THE INVENTION

### 1. Field of the Invention

The present invention relates to a wind duct with a silencer.

### 2. Description of the Related Art

In a case where wind from an air conditioner, a blower, or the like is blown through a wind duct such as a duct, for example, noise or the like caused by an operation of the blower can be propagated to a blowing destination through the wind duct. A technique for silencing such noise at an intermediate position of the wind duct has already been developed, and a technique disclosed in JP2004-069173A is given an example thereof.

In an air conditioning and heating machine disclosed in JP2004-069173A, a radial fan assembly is provided at an outdoor unit and takes in outdoor air to send wind to an indoor unit. In this case, air sent to the indoor unit passes through a supply and exhaust duct, and a silencer (specifically, a muffler) provided in the supply and exhaust duct reduces sound transmitted through the supply and exhaust duct.

### SUMMARY OF THE INVENTION

In a case where the silencer is provided at the wind duct, generally, the silencer is disposed on an upstream side of the wind duct, for example, near the blower, due to a reason or the like that it is difficult to secure an installation space near an outlet of the wind duct. On the other hand, a blowing amount is increased for a purpose of efficiently supplying wind in some cases, and in this case, a wind speed in the wind duct rises. Due to such a rise in wind speed, noise, particularly high-frequency noise, is generated in some cases.

Then, in a case where noise is generated at a position on a downstream side of the silencer in the wind duct, the noise propagates to the outlet of the wind duct and is released from the outlet. For this reason, even in a case where the silencer is disposed on the upstream side of the wind duct, a function of the silencer may not be appropriately exhibited with respect to the noise generated on the downstream side thereof (that is, generated sound in the wind duct caused by blowing in the wind duct), and there is a possibility in which a desired silencing effect is not obtained.

The present invention has been devised in view of the circumstances, and an object thereof is to solve the following problem. That is, an object of the present invention is to provide a wind duct with a silencer that can efficiently reduce sound propagating in a wind duct in a case where wind from a blower is sent through the wind duct, thereby solving the above problem.

In order to achieve the object, the present invention has the following configurations.

[1] A wind duct with a silencer comprising a wind duct in which wind sent from a blowing source flows and a first silencer and a second silencer that reduce sound propagating in the wind duct through a passive silencing method and that have frequency bands of sound to be reduced different from each other, in which the first silencer having a lower frequency band is disposed at a position closer to the blowing source, the second silencer having a higher frequency band is disposed at a position farther away from the blowing source, and among peak frequencies of generated sound in the wind duct caused by blowing in the wind duct, a frequency of a primary silencing peak of the second silencer is equal to or higher than a peak frequency at which an intensity of the generated sound is at its maximum.

[2] The wind duct with a silencer according to [1], in which in a case where a distance from a downstream end of the first silencer to an outlet of the wind duct is defined as L, the second silencer is disposed at a position where a distance from a downstream end of the second silencer to the outlet of the wind duct is less than L/2.

[3] The wind duct with a silencer according to [1] or [2], in which in a case where a size of a space surrounded by an outer wall surface of the first silencer is defined as a volume of the first silencer and a size of a space surrounded by an outer wall surface of the second silencer is defined as a volume of the second silencer, the volume of the second silencer is smaller than the volume of the first silencer.

[4] The wind duct with a silencer according to any one of [1] to [3], in which a minimum value of a diameter of the wind duct or a minimum value of a corresponding circular diameter of the wind duct is 150 mm or less.

[5] The wind duct with a silencer according to any one of [1] to [4], in which an in-silencer wind duct constituting a part of the wind duct is included inside each of a first housing provided in the first silencer and a second housing provided in the second silencer, and at least one of the first housing or the second housing is entirely or partially formed of a resin material.

[6] The wind duct with a silencer according to any one of [1] to [5], in which a sound absorbing material formed of a resin material is disposed in at least one of the first silencer or the second silencer.

[7] The wind duct with a silencer according to any one of [1] to [6], in which at least one of the first silencer or the second silencer has an expansion portion, the expansion portion has an inner space that has a cross section, which is orthogonal to an extending direction of the wind duct, larger than the wind duct, and the inner space of the expansion portion includes an in-silencer wind duct constituting a part of the wind duct and a rear surface space positioned outside the in-silencer wind duct.

[8] The wind duct with a silencer according to any one of claims [1] to [7], in which the wind duct penetrates a wall separating two spaces, and among the two spaces, the first silencer is disposed in one space, and the second silencer is disposed in the other space.

[9] The wind duct with a silencer according to [8], in which the wall separates an inner space of a room accommodating a person and an outside of the room, and a space where the second silencer is disposed is the inner space of the room.

[10] The wind duct with a silencer according to [8] or [9], in which the second silencer is disposed at a position adjacent to the wall in the other space.

[11] The wind duct with a silencer according to any one of [1] to [10], in which an in-silencer wind duct constituting a part of the wind duct is included inside each of the first silencer and the second silencer, and the in-silencer wind duct of the second silencer forms an end part of the wind duct on an outlet side.

[12] The wind duct with a silencer according to any one of [1] to [11], in which the wind duct is connected to an exhaust port of a fan that is the blowing source.

In the wind duct with a silencer of the present invention, the first silencer having a lower frequency band for silencing is installed at a position closer to the blowing source, and the second silencer having a higher frequency band for silencing is installed at a position farther away from a blowing source. In addition, among the peak frequencies of the generated sound in the wind duct caused by blowing in the wind duct, the frequency of the primary silencing peak of the second silencer is equal to higher than the peak frequency at which the intensity of the generated sound is at its maximum. Accordingly, sound propagating in the wind duct in a case where wind from the blower is sent through the wind duct can be efficiently reduced.

### BRIEF DESCRIPTION OF THE DRAWINGS

FIG. 1 is a view showing a blowing system in which a wind duct with a silencer according to one embodiment of the present invention is used.

FIG. 2 is a cross-sectional view of a first silencer of the wind duct with a silencer according to the embodiment of the present invention.

FIG. 3 is a cross-sectional view showing a first modification example of the first silencer.

FIG. 4 is a cross-sectional view showing a second modification example of the first silencer.

FIG. 5 is a cross-sectional view showing a third modification example of the first silencer.

FIG. 6 is a view showing a configuration of measuring a spectrum of generated sound in the wind duct.

FIG. 7 is a cross-sectional view of a second silencer of the wind duct with a silencer according to the embodiment of the present invention.

FIG. 8 is a schematic view showing a positional relationship between the first silencer and the second silencer.

FIG. 9 is an explanatory view of dimensions of each portion of the first silencer used in example 1.

FIG. 10 is an explanatory view of dimensions of each portion of the second silencer used in example 1.

FIG. 11 is a graph showing a silencing performance of each silencer used in example 1 and comparative example.

FIG. 12 is a graph showing measurement results of a silencing effect in each of example 1 and comparative example.

FIG. 13 is a graph showing measurement results of a silencing effect in each of tests 1 to 3.

### DESCRIPTION OF THE PREFERRED EMBODIMENTS

A wind duct with a silencer according to an embodiment of the present invention will be described in detail below with reference to a suitable embodiment shown in the accompanying drawings. The following embodiment is merely an example in order to facilitate understanding of the present invention and does not limit the present invention. That is, a configuration of the present invention can be changed or improved from the following embodiment without departing from the gist of the present invention.

In addition, a material, a shape, and the like of each member used in order to implement the present invention can be set in any manner in accordance with a purpose of use of the present invention and a technical level or the like at the time of implementation of the present invention, unless otherwise specified. In addition, the present invention includes an equivalent thereof.

In addition, in the present specification, a numerical range represented by using “to” means a range including numerical values written before and after “to” as a lower limit value and an upper limit value.

In addition, in the present specification, the terms “orthogonal”, “perpendicular”, and “parallel” include a range of errors accepted in the technical field to which the present invention belongs. For example, the terms “orthogonal”, “perpendicular”, and “parallel” in the present specification mean being in a range of less than +10° with respect to being orthogonal, perpendicular, or parallel in a strict sense. An error from being orthogonal or parallel in a strict sense is preferably 5° or less and more preferably 3° or less.

In addition, in the present specification, the meanings of “the same”, “identical” and “equal” may include a range of errors generally accepted in the technical field to which the present invention belongs.

In addition, in the present specification, the meanings of “the entire”, “any”, and “all” can include a range of errors generally accepted in the technical field to which the present invention belongs and can include a case of, for example, 99% or more, 95% or more, or 90% or more in addition to a case of 100%.

In addition, the term “silencing” in the present invention is reducing sound and is a concept that includes both sound insulation and sound absorption. Sound insulation means blocking sound, in other words, not allowing transmission of sound. In addition, the blocking of sound includes reflection of sound (acoustics) and cancellation of sound (acoustics). Sound absorption means reducing reflected sound, that is, absorbing sound (acoustics).

[Basic Configuration of Wind Duct with Silencer of Embodiment of Present Invention]

A basic configuration of the wind duct with a silencer according to one embodiment of the present invention (hereinafter, referred to as the present embodiment) will be described with reference to the drawings.

In the following description, a “blowing direction” means a direction in which wind flows in the wind duct toward an outlet and corresponds to an extending direction of the wind duct. In addition, a downstream side means an outlet side of the wind duct in the blowing direction, and an upstream side means an inlet side of the wind duct (that is, a side on which a blowing source 10 to be described later is disposed).

The wind duct with a silencer according to the present embodiment (hereinafter, referred to as a wind duct with a silencer 100) is used in a blowing system, particularly a blowing system S for a building. The blowing system S is used in order to transport (blow) wind to a predetermined space (for example, a room or the like) in a building for the purpose of air conditioning, ventilation, or the like. The building includes a detached house, each dwelling unit in an apartment such as condominium, a store such as a restaurant and a shop, and a facility such as a hospital, a department store, and a movie theater.

The term “wind” is an artificial air or a flow of a gas (air flow). Although the composition of air or a gas constituting wind and a ratio between respective components are not particularly limited, description will be made below assuming a case where normal air is blown.

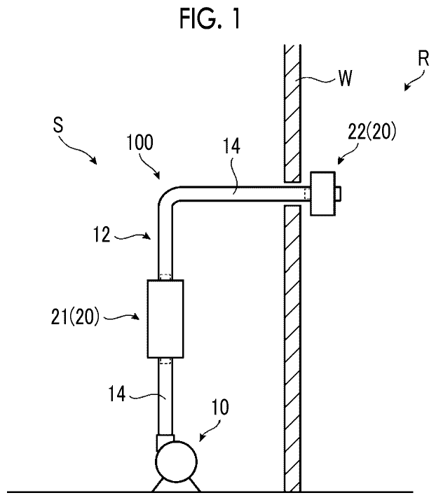

As shown in FIG. 1, the blowing system S is composed of the blowing source 10 and the wind duct with a silencer 100. As shown in FIG. 1, the wind duct with a silencer 100 comprises a wind duct 12 connected to the blowing source 10 and a silencer 20 that reduces sound (noise) propagating in the wind duct 12 during blowing.

The blowing source 10 is a device that comprises an electric motor such as a motor and that operates and blows wind in response to starting of the electric motor and is specifically a blowing fan constituting an air conditioner or a blowing fan for ventilation. As the fan, a well-known fan such as an axial fan (propeller fan), a sirocco fan, a turbo fan, a centrifugal fan, and a line flow fan (registered trademark) can be used.

The wind duct 12 is a flow passage through which wind sent from the blowing source 10 flows. A portion of the wind duct 12 excluding the silencer 20 is formed by a tubular wind duct forming member 14 such as a duct, a pipe, or a hose. A material, a structure, and the like of the wind duct forming member 14 are not particularly limited. From a perspective of facilitating the laying of the wind duct 12, for example, a flexible hose such as a vinyl hose, a flexible hose, and a Ty-Duct hose may be used as the wind duct forming member 14.

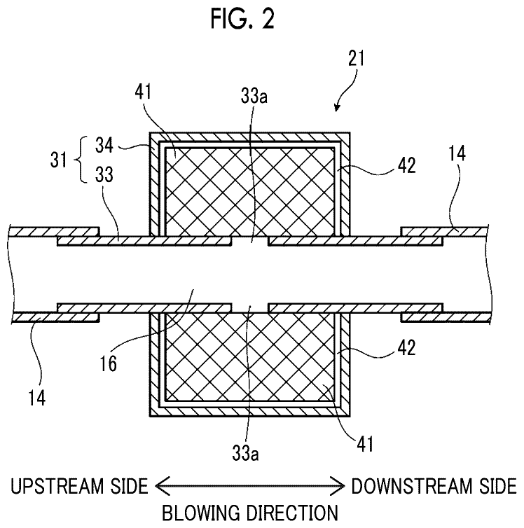

In addition, a part of the wind duct 12 is disposed inside the silencer 20. In other words, an inside of the silencer 20 constitutes a portion of the wind duct 12, that is, an in-silencer wind duct 16 (see FIG. 2).

In the present embodiment, a cross-sectional shape of the wind duct 12 is, for example, circular or rectangular. A cross section of the wind duct 12 is a cross section in which the blowing direction at a position of the cross section, that is, the extending direction of the wind duct 12 is a normal line. The cross-sectional shape of the wind duct 12 is not particularly limited and may be, for example, a quadrangle other than a rectangle, a polygon other than a rectangle, or an irregular shape. In addition, in the following description, a “cross-sectional area” is a size of the cross section and represents an area of a range surrounded by an outer edge of the cross section.

One end (upstream end) of the wind duct 12 is connected to an exhaust port of a fan that is the blowing source 10. The other end (downstream end) of the wind duct 12 is disposed in a space corresponding to a blowing destination in the building. More specifically, as shown in FIG. 1, the blowing destination in the present embodiment is an inside (indoor space) of a room R where a person is accommodated, and an inner space of the room R and an outside of the room R are separated by a wall W. In addition, as shown in FIG. 1, the fan, which is the blowing source 10, is disposed in a space (outdoor space) outside the room R.

That is, in the present embodiment, a part of the wind duct 12 is disposed along the wall W that separates the indoor space and the outdoor space and enters the room R, which is the blowing destination, through the wall W at a suitable place. Herein, the indoor space and the outdoor space are two spaces which are separated by the wall W and which are adjacent to each other, the outdoor space corresponds to one of the two spaces, and the indoor space corresponds to the other space.

The wind duct 12 may be laid to send wind from the outdoor blowing source 10 into the room R, and a route of the wind duct 12 is not particularly limited.

As described above, a through-hole through which the wind duct 12 (strictly speaking, the wind duct forming member 14) is passed is formed in the wall W. A size (diameter) of the through-hole may be designed to a suitable value according to the building where the blowing system S is used, but is generally 150 mm or less. A minimum value of a diameter of the wind duct 12 may be 150 mm or less in correspondence with the diameter of the through-hole. Herein, in a case where the cross-sectional shape of the wind duct 12 is a circle, the diameter of the wind duct 12 is a diameter of the circle, and in a case where the cross-sectional shape of the wind duct 12 is not a circle, the diameter of the wind duct 12 is a corresponding circular diameter of the shape.

The size of the through-hole is, for example, 150 mm or less in a store and 100 mm or less in a house. In addition, in a case where the wind duct forming member 14 such as a duct and a hose is used in a house, the minimum value of the diameter of the wind duct 12 is 50 mm or less. In addition, from a perspective of molding accuracy, the minimum value of the diameter of the wind duct 12 is preferably 1 mm or more.

In addition, the wall W through which the wind duct 12 penetrates may be a ceiling wall that separates a space behind a ceiling and a space (room) below the ceiling in the building. Alternatively, the wall may be an outer wall that separates indoors and outdoors in the building. That is, the wind duct 12 may be disposed along the outer wall of the building and may enter the building (indoors) through the outer wall at a suitable place.

While the fan, which is the blowing source 10, is being started, wind flows in the wind duct 12 at flow rate corresponding to a rated output of the electric motor of the fan, and the wind speed is, for example, approximately 9 m/s. That is, the wind speed in the wind duct 12 is determined according to the specification of the blowing source 10 and specifically is set within a range determined according to a performance or the like of the blowing source 10.

The wind speed means an average wind speed in a cross section of each portion of the wind duct 12. The average wind speed in the cross section is a wind speed calculated based on the amount of wind flowing in the wind duct 12 per unit time (for example, 1 second) and is, for example, a wind speed acquired by simply dividing the amount of wind by a cross-sectional area. An anemometer is installed at the outlet of the wind duct 12, and the amount of wind can be measured from a wind speed measured by the anemometer.

The silencer 20 is a device that reduces sound propagating in the wind duct 12 through a passive silencing method. The passive silencing method is a silencing method different from an active method of outputting control sound in a phase opposite to sound (noise) to be silenced, such as an active noise canceller (ANC), to reduce noise. Specifically, the silencer 20 reduces noise through any one method of sound absorption, resonance (acoustic resonance), or sound reflection in the silencer 20 or a combination thereof.

In the present embodiment, the silencer 20 is composed of a plurality of silencers including a first silencer 21 and a second silencer 22. The plurality of silencers may be three or more silencers. In this case, the silencer positioned on the most upstream side (blowing source 10 side) corresponds to the first silencer 21, and the silencer positioned on the most downstream side (side opposite to the blower source 10) corresponds to the second silencer 22.

A frequency band of sound to be silenced is different between the first silencer 21 and the second silencer 22. Herein, the fact that the frequency band of sound to be silenced is different means that a frequency of a primary silencing peak (that is, a frequency of a silencing peak with the lowest frequency) in a silencing spectrum of the silencer is different. However, without being limited thereto, and the fact that the frequency band of sound to be silenced is different may be being different in a main silencing band, specifically, in a frequency band in which a silencing degree is equal to or larger than a predetermined value.

The silencing spectrum of the silencer 20 indicates the silencing degree of the silencer 20 at each frequency. The silencing degree is a scale indicating a silencing performance of the silencer 20, and for example, a larger value indicates a higher silencing performance, such as a transmission loss and a sound absorption coefficient. The transmission loss of the silencer 20 can be calculated from transmittance measured through acoustic pipe measurement. In an acoustic pipe measurement method, according to “ASTM E2611-09: Standard Test Method for Measurement of Normal Incidence Sound Transmission of Acoustical Materials Based on the Transfer Matrix Method”, a transmittance and reflectivity measurement system using a 4-terminal microphone (not shown) is prepared, and evaluation is performed. In this case, for example, in a case where an internal diameter of an acoustic pipe is set to 4 cm, measurement can be performed up to approximately 4,000 Hz by the measurement system. In addition, WinZacMTX manufactured by Nihon Onkyo Engineering Co., Ltd. can be used in the same measurement.

Hereinafter, a configuration of each of the first silencer 21 and the second silencer 22 will be described with reference to FIGS. 1 to 8. FIGS. 2 to 5 and 7 show cross-sectional views of each silencer (including modification examples), and a cross section of the silencer is a cross section parallel to the blowing direction in the silencer, that is, the extending direction of the wind duct.

### (First Silencer)

The first silencer 21 is a silencer in which a frequency band of sound to be silenced is low compared to the second silencer 22. In addition, as shown in FIG. 1, the first silencer 21 is positioned on the upstream side of the second silencer 22, that is, is disposed at a position closer to the blowing source 10 than the second silencer 22 is.

The first silencer 21 is used for the purpose of reducing noise (hereinafter, also referred to as noise derived from the blowing source) caused by operating sound of the fan. For this reason, as shown in FIG. 1, the first silencer 21 is disposed on the downstream side of the exhaust port of the fan, which is the blowing source 10, at a position slightly away from the exhaust port. In addition, in the present embodiment, the first silencer 21 is disposed in the outdoor space in the same manner as the fan and specifically, as shown in FIG. 1, is disposed at an intermediate middle of a portion of the wind duct 12 that is provided in the outdoor space. Accordingly, noise derived from the blowing source can be appropriately silenced by the first silencer 21.

An installation position, an installation method, and the like of the first silencer 21 are not particularly limited.

The configuration of the first silencer 21 is designed such that the silencing spectrum corresponds to a spectrum of noise derived from the blowing source and the noise derived from the blowing source can be effectively reduced. The spectrum of the noise derived from the blowing source is an acoustic spectrum indicating an intensity of the noise at each frequency (specifically, a noise amount or a sound pressure, and a unit is dB). The intensity of the noise derived from the blowing source can be measured by connecting the exhaust port of the blowing source 10 and a reverberation chamber by a duct or a hose, operating the blowing source 10 to blow wind at a constant amount of wind, and measuring the intensity of the noise generated in this case with a plurality of microphones scattered in the reverberation chamber.

The first silencer 21 may reduce noise derived from the blowing source, and the silencing method thereof is not particularly limited. However, the first silencer 21 according to the present embodiment reduces the noise through resonance (acoustic resonance) and sound absorption. To describe specifically, as shown in FIG. 2, the first silencer 21 has a first housing 31 and a sound absorbing material 41 disposed in the first housing 31 and performs silencing through resonance in the housing and sound absorption by the sound absorbing material 41.

In the present embodiment, as shown in FIG. 2, the first housing 31 is composed of a tubular portion 33 and an expansion portion 34. The tubular portion 33 is a portion having a cylindrical shape or a square tubular shape, one end thereof is connected to the wind duct forming member 14 extending from the blowing source 10, and the other end thereof is connected to the wind duct forming member 14 extending toward the outlet. That is, an inside of the tubular portion 33 of the first housing 31 constitutes a part of the wind duct 12 (that is, the in-silencer wind duct 16).

In addition, as shown in FIG. 2, a hole (hereinafter, a communication hole 33a) penetrating an outer peripheral wall of the tubular portion 33 is formed in a central portion of the tubular portion 33.

The expansion portion 34 is a box-shaped portion having a cavity (expansion space) having a cross-sectional area larger than that of the wind duct 12 inside. The cross-sectional area of the expansion portion 34 is a size of a cross section of the expansion portion 34, and the cross section of the expansion portion 34 is a cross section in which the blowing direction at a position of the cross section, that is, the extending direction of the wind duct 12 is the normal line.

In the present embodiment, as shown in FIG. 2, the expansion portion 34 is provided at a position surrounding the central portion of the tubular portion 33 in which the communication hole 33a is formed. The tubular portion 33 is provided in a state of passing through the expansion portion 34 and penetrating side walls of the expansion portion 34 at both end portions of the tubular portion 33 as shown in FIG. 2. In other words, an inner space of the expansion portion 34 includes the in-silencer wind duct 16 formed by an inner space of the tubular portion 33. In addition, the inner space of the expansion portion 34 includes a rear surface space 42 that is a space positioned outside the tubular portion 33. The rear surface space 42 and the in-silencer wind duct 16 communicate with each other via the communication hole 33a formed in the tubular portion 33.

With the configuration described above, the first housing 31 of the first silencer 21 functions as a resonance type silencer, specifically, a Helmholtz resonance type silencer. That is, in a case where sound having the same frequency as a resonance frequency passes through the inside of the tubular portion 33 (that is, the in-silencer wind duct 16) in the first housing 31, air in the communication hole 33a vibrates, and sound energy is converted into thermal energy due to a viscous loss in this case. In this manner, the first silencer 21 reduces noise through resonance in the first housing 31.

The resonance type silencer may convert the sound energy into the thermal energy through resonance of a film or a plate to absorb sound.

A material constituting the first housing 31 is not particularly limited, and a metal material, a resin material, a paper material, a reinforced plastic material, a carbon fiber, and the like can be used. However, it is preferable that the first housing 31 is formed of a resin material from a perspective of ensuring ease of molding and freedom of design and enabling more inexpensive manufacturing.

Examples of the resin material include an acrylic resin, polymethyl methacrylate, polycarbonate, polyamidimide, polyalylate, polyetherimide, polyacetal, polyetheretherketone, polyphenylene sulfide, polysulfone, polyethylene terephthalate, polybutylene terephthalate, polyimide, a copolymer synthetic resin of acrylonitrile, a flame-retardant ABS resin, butadiene, and styrene (ABS resin), triacetylcellulose (TAC), polypropylene (PP), polyethylene (PE), polystyrene (PS), an acrylate sthrene acrylonitrile (ASA) resin, a polyvinyl chloride (PVC) resin, and a polylactic acid (PLA) resin.

Examples of the reinforced plastic material include carbon fiber reinforced plastics (CFRP) and glass fiber reinforced plastics (GFRP).

In addition, the entire first housing 31 may be manufactured of a resin material through injection molding or the like. Alternatively, a part of the first housing 31 may be formed of a material other than the resin material, and the remaining portion may be formed of the resin material. In this case, a part of the first housing 31 may be formed of a metal plate or the like, and the portion may be vibrated to reduce noise.

In addition, in the first housing 31, a portion of the expansion portion 34 may have a thickness (plate thickness) different from a thickness of a peripheral portion while the portion is formed of the same material as the peripheral portion.

As shown in FIG. 2, the sound absorbing material 41 fills the inside of the expansion portion 34 in the first housing 31, specifically, the rear surface space 42. In the present embodiment, the sound absorbing material 41 has a cylindrical shape, and the tubular portion 33 is disposed inside the sound absorbing material 41. That is, the sound absorbing material 41 is disposed in the expansion portion 34 in a state of surrounding the tubular portion 33 constituting the in-silencer wind duct 16. Then, in a case where sound in the in-silencer wind duct 16 enters the rear surface space 42 through the communication hole 33a, the sound is absorbed by the sound absorbing material 41.

As the sound absorbing material 41, a material that absorbs sound by converting sound energy into thermal energy can be used. A material constituting the sound absorbing material 41 is not particularly limited, and examples thereof include a porous material such as a foaming body, a foaming material, and a nonwoven fabric-based sound absorbing material.

Specific examples of the foaming body and the foaming material include foaming urethane foam such as CALMFLEX F manufactured by INOAC CORPORATION and urethane foam manufactured by Hikari Co., Ltd., flexible urethane foam, a ceramic particle sintered material, phenol foam, melamine foam, an insulation board, and polyamide foam.

Specific examples of the nonwoven fabric-based sound absorbing material include a microfiber nonwoven fabric such as Thinsulate manufactured by 3M Company, a plastic nonwoven fabric such as a polyester nonwoven fabric (including a two-layer configuration fabric that has a thin surface-side nonwoven fabric having a high density and a back-side nonwoven fabric having a low density) such as White Kyuon manufactured by TOKYO Bouon and QonPET manufactured by Bridgestone KBG Co., Ltd. and an acrylic fiber nonwoven fabric, a natural fiber nonwoven fabric such as wool and felt, a meltblown nonwoven fabric, a metal nonwoven fabric, a glass nonwoven fabric, a floor mat, and a carpet.

In addition to the description above, various sound absorbing materials, such as a sound absorbing material consisting of a material including a minute amount of air, for example, a sound absorbing material consisting of glass wool, rock wool, a plaster board, a wood wool cement board, and a nanofiber-based fiber, can be used. Examples of the nanofiber-based fiber include a silica nanofiber and an acrylic nanofiber, such as XAI manufactured by Mitsubishi Chemical Corporation.

In a case where a material having hydrophilicity (for example, glass wool) is used as the sound absorbing material 41 described above, there is a possibility in which mold is generated in the sound absorbing material when high-humidity wind flows in the silencer. For a reason of suppressing generation of such mold, a material for the sound absorbing material 41 is preferably a material which is a non-metallic body and which is other than an inorganic substance, specifically a resin material, and the sound absorbing material 41 composed of a resin fiber having water repellency is more preferable. In addition, in a configuration where the sound absorbing material 41 is formed of a resin material, scattering or the like of glass fibers generated from the sound absorbing material formed of glass wool can be suppressed.

In addition, flow resistivity of the sound absorbing material 41 is preferably 1,000 (Pa×s/m²) to 100,000 (Pa×s/m²). In a case where the sound absorbing material 41 is a laminated structure obtained by overlapping a plurality of layers, flow resistivity of the entire structure can be measured, and the flow resistivity can be calculated from the thickness of the entire structure.

A configuration of the silencer that performs silencing through sound absorption is considered in addition to the configuration using the sound absorbing material 41. For example, a silencer that is composed of a plate-like body or a film-like body which resonates as sound having a frequency close to the resonance frequency is incident and that absorbs sound by converting sound energy into thermal energy due to an internal loss of a plate or a film may be used.

In addition, a resonance type sound absorbing structure consisting of a plate with a hole can also be used. In this sound absorbing structure, in a case where sound having the same frequency as the resonance frequency hits air in the hole, the air in the hole portion vibrates, and sound energy is converted into thermal energy due to a viscous loss in that case.

Further, a composite sound absorbing structure in which the sound absorbing structure and the sound absorbing material are combined can also be used.

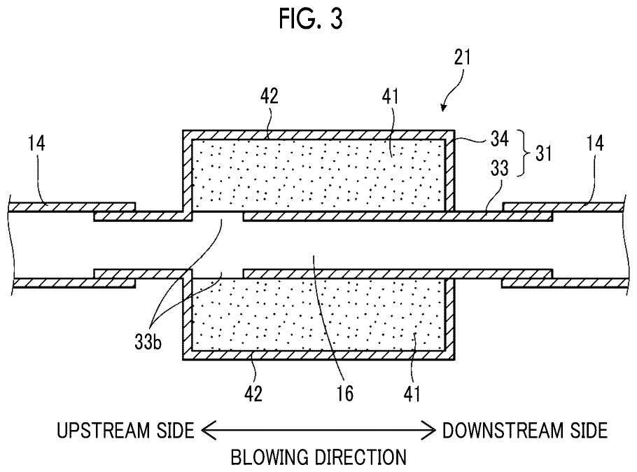

The configuration of the first silencer 21 is not limited to the configuration example described above and may be other configurations. The first silencer 21 may be, for example, a side branch type silencer as shown in FIG. 3. Specifically, an opening portion 33b may be provided in a portion of the tubular portion 33 on the upstream side, and the opening portion 33b and the rear surface space 42 may form a space (hereinafter, an L-shaped space) that is bent in an L-shape in which the opening portion 33b and the rear surface space 42 are continuous to each other. The L-shaped space is adjacent to the in-silencer wind duct 16 on the side of the in-silencer wind duct 16. Sound propagating in the in-silencer wind duct 16 is reduced by the sound absorbing material 41 in the L-shaped space and the rear surface space 42.

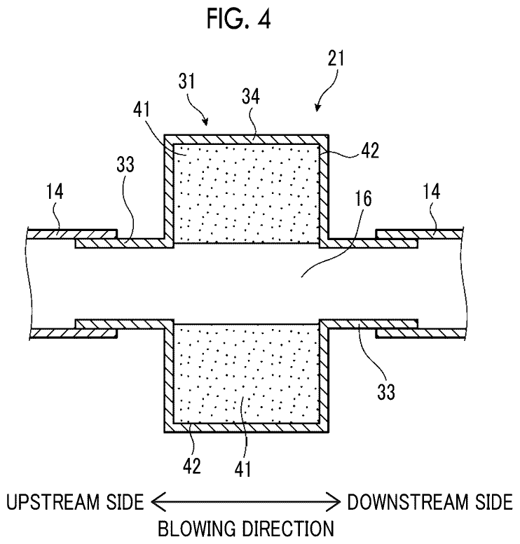

In addition, the first silencer 21 may be, for example, a cavity type structure silencer as shown in FIG. 4. Specifically, a portion of the tubular portion 33, which is positioned in the expansion portion 34, is missing, and the in-silencer wind duct 16 is surrounded by the sound absorbing material 41. In a cross section of the in-silencer wind duct 16, a part of an outer edge of the in-silencer wind duct 16 may be in contact with the sound absorbing material 41, and the remaining portion may be in contact with an inner wall of the expansion portion 34.

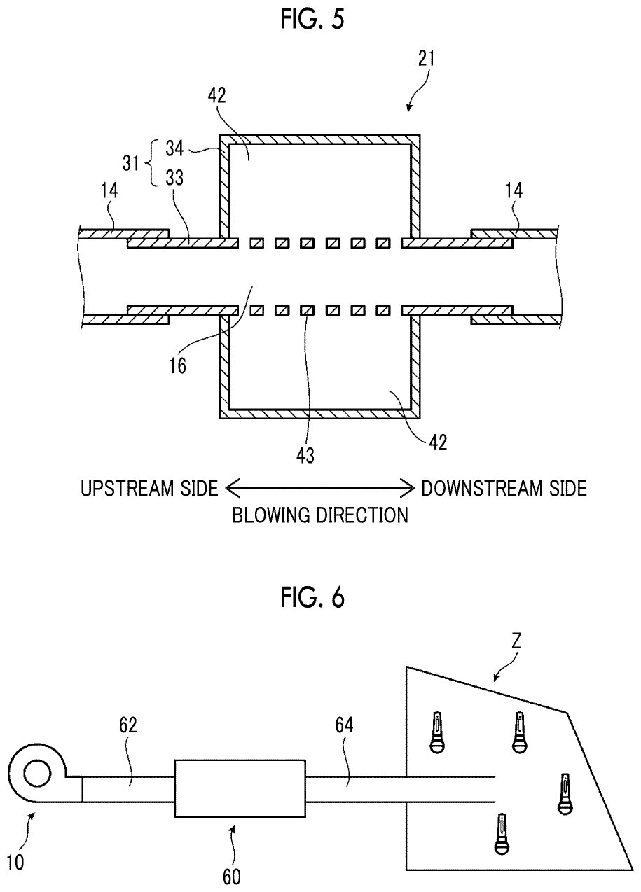

In addition, the first silencer 21 may be a silencer having a structure using a porous plate 43 as shown in FIG. 5. Specifically, a portion of the tubular portion 33, which is positioned in the expansion portion 34, is composed of the porous plate 43. The porous plate 43 is a micro perforated plate in which a large number of through-holes having a diameter of approximately 100 μm are formed, and sound is absorbed by micro holes and a space (that is, the rear surface space 42) outside the micro holes. As the micro perforated plate, for example, an aluminum micro perforated plate such as SUONO manufactured by Taisei Kogyo Corporation, a vinyl chloride resin micro perforated plate such as Di-NOC manufactured by 3M Company, and the like can be used.

### (Second Silencer)

The second silencer 22 is a silencer in which a frequency band of sound to be silenced is high compared to the first silencer 21. In addition, as shown in FIG. 1, the second silencer 22 is positioned on the downstream side of the first silencer 21, that is, is disposed at a position farther away from the blowing source 10 than the first silencer 21 is.

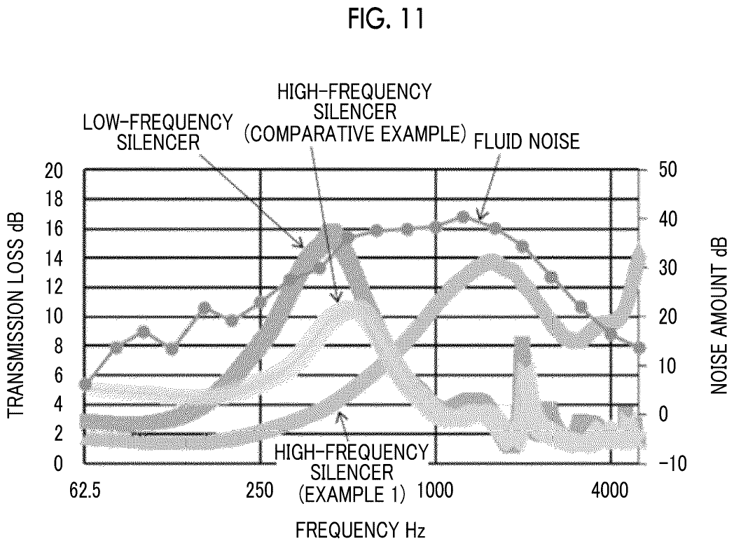

The second silencer 22 is used for the purpose of reducing noise (hereinafter, also referred to as fluid noise) generated in the wind duct 12 due to blowing in the wind duct 12 during an operation of the fan, which is the blowing source 10. The fluid noise is noise generated in the wind duct 12, particularly in a portion on the downstream side of the first silencer 21 and has a peak in a frequency band (800 Hz or more, for example, near 1 kHz) higher than noise derived from the blowing source in the spectrum thereof (see FIG. 11). The spectrum of the fluid noise is an acoustic spectrum indicating an intensity of the fluid noise at each frequency (specifically, a noise amount or a sound pressure, and a unit thereof is dB) and can be measured by a measurement system shown in FIG. 6.

To describe the measurement system shown in FIG. 6, the blowing source 10 and an inlet of a measurement silencer 60 are connected by an upstream wind duct 62 consisting of a hose or the like, and a downstream wind duct 64 consisting of a hose or the like extends from an outlet of the measurement silencer 60 to a reverberation chamber Z. The blowing source 10 is operated to blow wind, wind flows in each of the upstream wind duct 62, the inside of the measurement silencer 60, and the downstream wind duct 64 at a constant amount of wind. In this case, noise derived from the blowing source is absorbed by the measurement silencer 60, and fluid noise mainly propagates in the wind duct on the downstream side of the measurement silencer 60. For this reason, the intensity of the fluid noise can be measured by measuring the intensity of sound released from the outlet of the downstream wind duct 64 in the above state with the plurality of microphones scattered in the reverberation chamber Z.

Fluid noise is sound generated in the wind duct 12 due to blowing in the wind duct 12 as described above. For this reason, even in a case where the silencer 20 is disposed on the upstream side of the wind duct 12, that is, on a side close to the blowing source 10, it is difficult to reduce fluid noise generated on the downstream side with the silencer 20, and there is a concern that a desired silencing effect is not obtained.

In addition, in a spectrum of fluid noise, a peak at which the intensity (sound pressure) of the fluid noise is the highest is at a relatively high frequency (for example, 1 kHz) as described above, but the noise intensity at the peak tends to increase as the wind speed increases. In particular, in the blowing system S in a general house or a store such as a restaurant, a blowing amount is increased for a reason of improving the performance of air conditioning or ventilation. On the other hand, due to a restriction on a disposition space for the wind duct forming member 14, a minimum value of the diameter of the wind duct 12 is further reduced and for example, may be set to 150 mm or less. For this reason, in the recent blowing system S, a wind speed in the wind duct 12 gradually increases, wind noise is generated, and as a result, the intensity of fluid noise tends to increase significantly.

For the above reason, as shown in FIG. 1, the second silencer 22 is disposed at a position farther away from the blowing source 10 than the first silencer 21 is and is disposed at a position close to the outlet of the wind duct 12, that is, the blowing destination. In the present embodiment, as shown in FIG. 1, the second silencer 22 is disposed in a space different from a space where the first silencer 21 is disposed, that is, the inner space of the room R. In addition, the second silencer 22 is disposed adjacent to a portion of the wind duct forming member 14, which is positioned on the most downstream side, and at a position on the downstream side of the portion, that is, an end part (terminal part) of the wind duct 12 on the outlet side. Accordingly, fluid noise can be appropriately silenced by the second silencer 22.

The installation position of the second silencer 22 is not limited to the position described above. However, as shown in FIG. 1, in a case where the first silencer 21 and the second silencer 22 are disposed in different spaces from each other separated by the wall W, an installation space for each silencer can be easily secured, compared to a case where both silencers are disposed in one space. In addition, as shown in FIG. 1, in a case where the second silencer 22 is disposed at a position adjacent to the wall W in the indoor space, the second silencer 22 is more suitably disposed in the indoor space, specifically, is easily disposed at a position where a collision with a person can be avoided.

In addition, an installation method of the second silencer 22 and the like are not particularly limited, and for example, a support such as a support bracket may be fixed to the wall W, and the second silencer 22 may be installed at a predetermined position with the support.

The configuration of the second silencer 22 is designed such that the silencing spectrum corresponds to a spectrum of fluid noise and the fluid noise can be effectively reduced. To describe specifically, as shown in FIG. 11 to be described later, a frequency of a primary silencing peak of the second silencer 22 is equal to or higher than a peak frequency (hereinafter, a peak frequency of fluid noise) at which the intensity of the fluid noise is at its maximum among peak frequencies of the fluid noise. The frequency of the primary silencing peak of the second silencer 22 is a lowest-order (lowest frequency side) peak frequency in the silencing spectrum of the second silencer 22.

As described above, in the present embodiment, as the frequency of the primary silencing peak of the second silencer 22 is equal to or higher than the peak frequency of the fluid noise and the second silencer 22 is disposed more on the downstream side in the wind duct 12, the fluid noise can be appropriately reduced by the second silencer 22.

The peak frequency of the fluid noise changes according to a flow speed of wind flowing in the wind duct 12 (wind speed). Herein, the peak frequency of the fluid noise in a case of a minimum wind speed value (a wind speed during fan starting, excluding a value during fan stoppage) in a range of a wind speed that can be realized by the fan, which is the blowing source 10, is defined as a “peak frequency at a minimum wind speed”. The frequency of the primary silencing peak of the second silencer 22 may be determined, for example, with the peak frequency at the minimum wind speed as reference, and in this case, may be set to the peak frequency at the minimum wind speed or more.

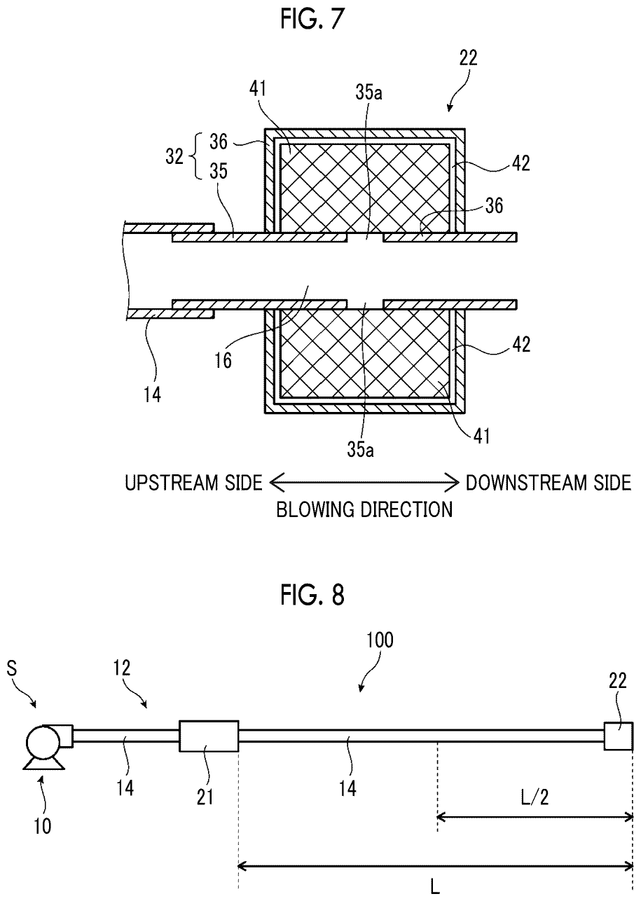

The second silencer 22 may be any silencer insofar as the silencer effectively reduces fluid noise, and a silencing method thereof is not particularly limited. However, the second silencer 22 of the present embodiment reduces noise through resonance (acoustic resonance) and sound absorption, as in the first silencer 21. A basic configuration of the second silencer 22 is substantially the same as that of the first silencer 21 except that a frequency band to be silenced is different and the size is smaller. That is, as shown in FIG. 7, the second silencer 22 has a second housing 32 and the sound absorbing material 41 disposed in the second housing 32 and performs silencing through resonance in the housing and sound absorption by the sound absorbing material 41.

In addition, as shown in FIG. 7, the inner space of the second housing 32 has a tubular portion 35 that constitutes the in-silencer wind duct 16 and an expansion portion 36 that surrounds a central portion of the tubular portion 35. As described above, the in-silencer wind duct 16 formed in the tubular portion 35 of the second housing 32 constitutes the terminal part (the end part on the outlet side) of the wind duct 12. In addition, the in-silencer wind duct 16 in the second housing 32 communicates with the rear surface space 42 of the expansion portion 36 through a communication hole 35a formed in the central portion of the tubular portion 35. Accordingly, the second housing 32 functions as a Helmholtz resonator.

In addition, a material constituting the second housing 32 is not particularly limited, and for example, a metal material, a resin material, a paper material, a reinforced plastic material, a carbon fiber, and the like can be used. In addition, it is preferable that the second housing 32 is entirely or partially formed of a resin material from a perspective of ensuring ease of molding and freedom of design and enabling inexpensive manufacturing. Examples of the resin material constituting the second housing 32 are the same as the examples of the resin material constituting the first housing 31 described above.

In a case where a part of the second housing 32 is formed of a material other than the resin material and the remaining portion is formed of the resin material, a part of the second housing 32 may be configured by a metal plate or the like, and the portion may be vibrated so that fluid noise can be reduced.

In addition, in the second housing 32, a portion of the expansion portion 36 may have a thickness (plate thickness) different from a peripheral portion while the portion is formed of the same material as the peripheral portion.

Further, in the inner space of the expansion portion 36, the sound absorbing material 41 is disposed in the rear surface space 42 positioned outside the tubular portion 35. Examples of a material constituting the sound absorbing material 41 provided in the second silencer 22 are the same as the examples of the material constituting the sound absorbing material 41 provided in the first silencer 21, and particularly, the sound absorbing material 41 composed of a resin material is suitable.

The sound absorbing structure in the second silencer 22 may be a structure other than the structure using the sound absorbing material 41 and may be composed of a plate-like body or a film-like body that resonates as sound having a frequency close to the resonance frequency is incident. In addition, a resonance type sound absorbing structure consisting of a plate with a hole can also be used. Further, a composite sound absorbing structure in which the sound absorbing structure and the sound absorbing material are combined can also be used.

In addition, a silencing structure of the second silencer 22 is not limited to the silencing structure shown in FIG. 7 as in the first silencer 21 and may be, for example, the side branch type silencer shown in FIG. 3, the cavity type silencer shown in FIG. 4, or the silencer having the structure using the porous plate 43 shown in FIG. 5.

In addition, in the present embodiment, as can be seen from FIG. 1, the volume of the second silencer 22 is smaller than the volume of the first silencer 21. Herein, the volume of the first silencer 21 is the size of a space surrounded by an outer wall surface of the first silencer 21, specifically, an outer wall surface of the first housing 31, that is a three-dimensional size of the first housing 31. In addition, the volume of the second silencer 22 is the size of a space surrounded by an outer wall surface of the second silencer 22, specifically, an outer wall surface of the second housing 32, that is, a three-dimensional size of the second housing 32. Accordingly, the second silencer 22 disposed indoors can be further reduced in size while ensuring a silencing effect of each silencer.

To describe more specifically, a silencing material used in a silencer, such as a sound absorbing material, more effectively exhibits a silencing effect in general as the size (volume) of the silencing material increases with respect to a wavelength of sound to be silenced. On the other hand, fluid noise is sound in a high frequency band, and a wavelength thereof is relatively short. Therefore, even in a case of a silencer having a relatively small size, a high silencing effect is exhibited with respect to the fluid noise. Therefore, by making the volume of the second silencer 22 smaller than the volume of the first silencer 21, an installation space for the second silencer 22 can be saved while maintaining a sufficient silencing effect. Such an effect is particularly significant in a case where the second silencer 22 is disposed in the indoor space.

In addition, in the present embodiment, the first silencer 21 and the second silencer 22 are disposed in the wind duct 12, and a positional relationship between both silencers is a positional relationship with which a better silencing effect is obtained. Hereinafter, the positional relationship between the first silencer 21 and the second silencer 22 in the wind duct 12 will be described with reference to FIG. 8.

In FIG. 8, the wind duct 12, the first silencer 21, and the second silencer 22 are shown in a simplified manner. In addition, for convenience of illustration, the wind duct 12 that is actually laid while being bent or curved is shown in FIG. 8 as an imaginary straight route.

In the wind duct 12, a distance from a downstream end of the first silencer 21 (specifically, a downstream end of the tubular portion 33) to the outlet of the wind duct 12 is defined as L. In the present embodiment, as shown in FIG. 8, the second silencer 22 is disposed at a position where a distance from a downstream end of the second silencer 22 (specifically, a downstream end of the tubular portion 35) to the outlet of the wind duct 12 is less than L/2. In other words, in the wind duct 12 according to the present embodiment, the downstream end of the first silencer 21 and the downstream end of the second silencer 22 are away from each other by L/2 or more.

In order to halve the intensity of fluid noise, it is necessary that an interval between the first silencer 21 and the second silencer 22 is at least L/2 or more. Therefore, in a case where the positional relationship is as described above, the fluid noise can be well reduced by the second silencer 22.

### OTHER EMBODIMENTS

Although the configuration of the wind duct with a silencer according to the embodiment of the present invention has been described above, the present invention is not limited to the embodiment described above, and other embodiments can also be considered.

In the embodiment described above, the first silencer 21 and the second silencer 22 are disposed in rooms that are separated by the wall W and that are positioned on opposite sides to each other. However, without being limited thereto, both the first silencer 21 and the second silencer 22 may be disposed in the same room. However, the embodiment described above is preferable from a perspective of achieving space saving of the second silencer 22 while maintaining a good silencing effect.

In the embodiment described above, the second silencer 22 is disposed at the terminal part of the wind duct 12. In other words, the in-silencer wind duct 16 in the second silencer 22 constitutes the end part of the outlet of the wind duct 12. However, without being limited thereto, the second silencer 22 may be disposed on the downstream side of the first silencer 21 or may be disposed at a position on the upstream side of the outlet of the wind duct 12.

In the embodiment described above, the first silencer 21 and the second silencer 22 comprise the expansion portions 34 and 36 having the inner space expanded more than the cross-sectional area of the wind duct, respectively. However, without being limited thereto, only one of the first silencer 21 or the second silencer 22 may comprise the expansion portion.

In addition, in the embodiment described above, each of the first housing 31 provided in the first silencer 21 and the second housing 32 provided in the second silencer 22 is formed of a resin material. However, without being limited thereto, only one of the first housing 31 or the second housing 32 may be formed of a resin material.

In addition, in the embodiment described above, the sound absorbing material 41 is disposed in each of the first silencer 21 and the second silencer 22, and a resin material is given as an example of a suitable material constituting each sound absorbing material 41. However, without being limited thereto, only the sound absorbing material 41 provided inside any one of the first silencer 21 or the second silencer 22 may be formed of a resin material.

Although the silencer 20 that reduces noise through resonance in the housing and sound absorption by the sound absorbing material has been described as the configuration of the silencer using the passive silencing method in the embodiment described above, the passive silencing method may be a method other than resonance, sound absorption, and reflection.

For example, in a silencer in which a vibration portion vibrates as sound hits a portion (vibrating portion) of a side wall of a housing, a configuration where the vibration is suppressed by attaching a vibration damping material to the vibrating portion to reduce noise may be adopted.

### EXAMPLES

Hereinafter, the present invention will be more specifically described with reference to an example. Materials, amounts used, ratios, the content of processing, processing procedures, and the like shown in the example below can be changed as appropriate without departing from the gist of the present invention. Therefore, the scope of the present invention is not to be construed as limiting by the example shown below.

### Example 1

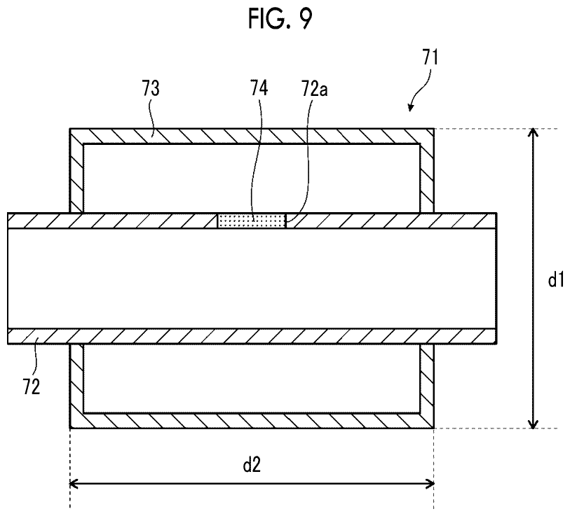

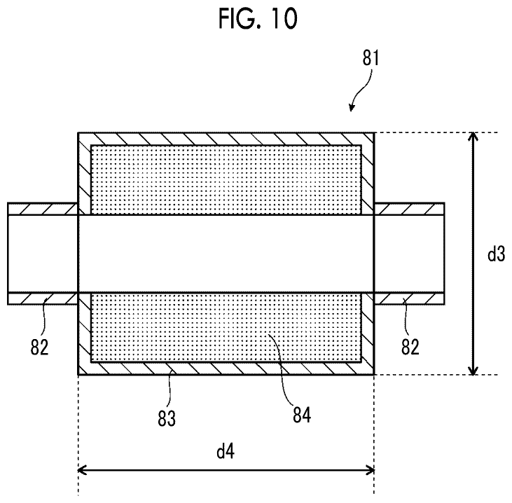

In example 1, a low-frequency silencer 71 that reduces noise derived from a blowing source and that is shown in FIG. 9 and a high-frequency silencer 81 that reduces fluid noise and that is shown in FIG. 10 are disposed with respect to a wind duct laid in order to send wind from the blowing source to a reverberation chamber. As the blowing source, two direct current (DC) type blowers (manufactured by SANYO Electric Co., Ltd., model number: 9BMC24P2G001) that are blowing fans are used. Each silencer is disposed according to the configuration shown in FIG. 1. Specifically, the low-frequency silencer 71 is disposed at a position closer to the blowing source than the high-frequency silencer 81 is.

An exhaust port of the blower and an upstream end part of the low-frequency silencer 71 are connected by a transparent vinyl hose (manufactured by Chubu Vinyl Industry Co., Ltd.) which is a wind duct forming member. An inner diameter of the vinyl hose is 28 mm, an outer diameter is 34 mm, and an entire length of the hose used in test 1 is 1.7 mm.

In addition, a downstream end part of the low-frequency silencer 71 and an upstream end part of the high-frequency silencer 81 are connected by a Ty-Duct hose (manufactured by Tiger Polymer Corporation, product name: Ty-Duct hose N type) which is a wind duct forming member. An inner diameter of the Ty-Duct hose is 32.5 mm, an outer diameter is 37 mm, and an entire length of the hose used in test 1 is 2.0 m.

The low-frequency silencer 71 corresponds to a first silencer according to the embodiment of the present invention and has the configuration shown in FIG. 9. Specifically, a communication hole 72a having a diameter of 20 mm is formed in a central portion of a cylindrical tubular portion 72 having an inner diameter of 28 mm, an outer diameter of 34 mm, and an entire length of 228 mm. The low-frequency silencer 71 is configured by surrounding the central portion of the tubular portion 72, in which the communication hole 72a is formed, with a rectangular parallelepiped expansion portion 73. A height (denoted by a symbol d1 in FIG. 9), a depth, and an entire length (denoted by a symbol d2 in FIG. 9) of the expansion portion 73 are 75.8 mm, 75.8 mm, and 78 mm, respectively. In addition, the volume of a housing of the low-frequency silencer 71 is 584 cm³. In addition, an inner space of the expansion portion 73 is a closed space, and the communication hole 72a is closed by the expansion portion 73. In addition, the communication hole 72a is closed by a sound absorbing material 74 (product name: QonPET) of Bridgestone KBG Co., Ltd.

The high-frequency silencer 81 corresponds to a second silencer according to the embodiment of the present invention and has the configuration shown in FIG. 10. Specifically, the high-frequency silencer 81 is configured by disposing an expansion portion 83 between two annular portions 82 having an inner diameter of 28 mm and an outer diameter of 31 mm. An inner diameter and a width (denoted by symbols d3 and d4 in FIG. 10) of the expansion portion 83 are 76.3 mm and 50 mm, respectively. In addition, an entire length of the high-frequency silencer 81 is 168 mm, and the volume of a housing of the high-frequency silencer 81 is 310 cm³. In addition, in the expansion portion 83, a wind duct (in-silencer wind duct) having the same diameter as the inner diameter of the annular portion 82 and a sound absorbing material 84 surrounding the wind duct are disposed. The sound absorbing material 84 consists of a sound absorbing material (product name: QonPET) of Bridgestone KBG Co., Ltd.

In example 1, the high-frequency silencer 81 is disposed at a terminal part of the wind duct.

### COMPARATIVE EXAMPLE

In a comparative example, a structure of the high-frequency silencer is different from that of example 1. The high-frequency silencer of comparative example has substantially the same structure as that of the low-frequency silencer 71 of example 1, although there is a difference in size. That is, the high-frequency silencer of comparative example has the configuration shown in FIG. 9 and comprises a cylindrical tubular portion having a communication hole formed in a central portion thereof and a rectangular parallelepiped expansion portion surrounding the central portion of the tubular portion. An inner diameter of the tubular portion is 28 mm, an outer diameter is 34 mm, an entire length is 222 mm, and a diameter of the communication hole is 20 mm. In addition, a height, a depth, and an entire length of the expansion portion are 75.8 mm, 75.8 mm, and 62 mm, respectively. In addition, the volume of a housing of the high-frequency silencer is 501 cm³. In addition, an inner space of the expansion portion is a closed space. In addition, the communication hole is closed by the expansion portion and is closed by the sound absorbing material 74 (product name: QonPET) of Bridgestone KBG Co., Ltd.

The configurations other than the high-frequency silencer are the same between comparative example and example 1.

### (Measurement of Silencing Spectrum of Silencer)

For each of the low-frequency silencer 71 and the high-frequency silencer 81 of example 1 and the high-frequency silencer of comparative example, a vertical incidence transmission loss spectrum which is a silencing spectrum is measured through the acoustic tube measurement method according to “ASTM E2611-09”. FIG. 11 shows the measurement results. A horizontal axis of FIG. 11 indicates a center frequency (unit is Hz) of a ⅓ octave band, and a vertical axis on the left side indicates a transmission loss (unit is dB).

FIG. 11 shows a noise spectrum of generated sound (that is, fluid noise) in a case where wind flows in the Ty-Duct hose having an entire length of 2 m at a wind speed of 9.3 m/s, together with the above measurement results. The vertical axis on the right side of FIG. 11 shows the noise amount (unit is dB) of the fluid noise.

As can be seen from FIG. 11, a silencing peak (a peak of a transmission loss) of each silencer satisfies the following relational expression (1).

$$fa 1 < fb 2 < fx < fb 1 \qquad ( 1 )$$

In expression (1), fa1 is a silencing peak (438 Hz) of the low-frequency silencer 71 in example 1, and fb2 is a silencing peak (518 Hz) of the high-frequency silencer in comparative example. fx is a peak (1,250 Hz) of a noise spectrum of the fluid noise, and fb1 is a silencing peak (1,568 Hz) of the high-frequency silencer 81 of example 1.

That is, in example 1, the primary silencing peak of the high-frequency silencer 81, which is the second silencer, is a peak frequency of the fluid noise, specifically, a peak frequency at which the noise amount is at its maximum or more. On the other hand, in comparative example, the primary silencing peak of the high-frequency silencer is less than the peak frequency at which the noise amount is at its maximum among the peak frequencies of the fluid noise.

### (Measurement of Silencing Effect)

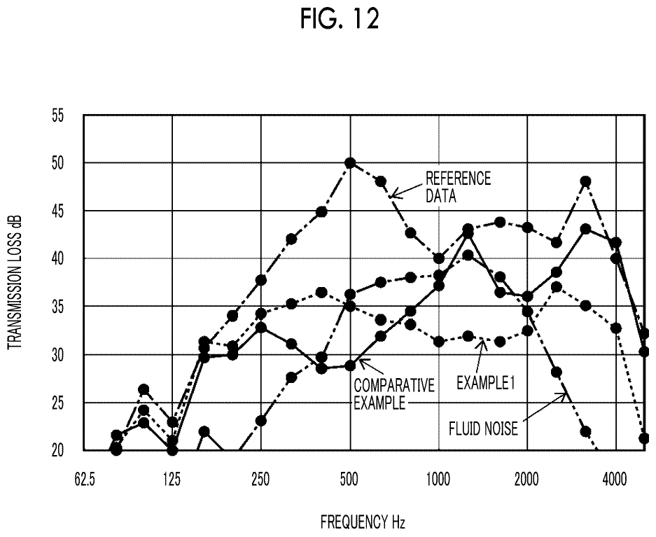

In each of example 1 and comparative example, wind blows from the blower such that the wind speed in the Ty-Duct hose constituting the wind duct is 9.1 m/s. Then, a noise spectrum indicating a noise amount at each frequency is acquired by measuring noise released from a terminal of the wind duct to the reverberation chamber with a microphone installed in the reverberation chamber. The measurement results are shown in FIG. 12. A horizontal axis of FIG. 12 indicates a center frequency (unit is Hz) of a ⅓-octave band, and a vertical axis indicates a noise amount (unit is dB).

In FIG. 12, a noise spectrum of fluid noise generated in the wind duct under the above conditions is shown together with the above measurement results. In addition, FIG. 12 shows, as reference data, a noise spectrum in a case where the blowing source and the blowing destination (reverberation chamber) are directly connected by the Ty-Duct hose without installing the silencer in the wind duct. In this reference data, the speed of wind flowing in the wind duct is set to 9.1 m/s, as in example 1 and comparative example.

As can be seen from FIG. 12, in example 1 and comparative example, noise corresponding to a peak appearing around 450 Hz in the reference data is removed by the low-frequency silencer. Therefore, among noise propagating in the wind duct toward the outlet, high-frequency fluid noise generated on the downstream side of the low-frequency silencer becomes dominant and significantly contributes to the entire noise.

In example 1 and comparative example, the high-frequency silencer is installed on the downstream side of the low-frequency silencer. However, as shown in FIG. 12, the fluid noise can be effectively reduced in example 1, but the fluid noise cannot be sufficiently silenced in comparative example. As a result, in example 1, the noise amount measured in the reverberation chamber is 45.7 dB, and the noise amount measured in comparative example is 49.4 dB. That is, it is found that a large silencing effect is obtained in example 1, and the silencing effect is small in comparative example. That is, it is clear that the fluid noise is effectively reduced, and a high silencing effect is obtained by making the primary silencing peak of the high-frequency silencer disposed on the downstream side of the wind duct equal to or higher than the peak frequency at which the noise amount is at its maximum among the peak frequencies of the fluid noise.

### <Regarding Test Related to Silencing Effect According to Disposition Position of Silencer>

Next, test 1 performed related to the silencing effect according to the disposition position of the silencer and tests 2 and 3 which are comparative tests thereof will be described.

### (Test 1)

In test 1, the same wind duct with a silencer as in example 1 described above is used. That is, in test 1, in the wind duct, the low-frequency silencer 71 shown in FIG. 9 is disposed at a position closer to the blowing source than the high-frequency silencer 81 is, and the high-frequency silencer 81 shown in FIG. 10 is disposed at the terminal part of the wind duct. Specifically, the high-frequency silencer 81 is disposed such that a distance from a downstream end of the low-frequency silencer 71 to the outlet of the wind duct is defined as L and a distance from a downstream end of the high-frequency silencer 81 to the outlet of the wind duct is less than L/2.

### (Test 2)

In test 2, the high-frequency silencer 81 is disposed on the downstream side of the low-frequency silencer 71 and near the low-frequency silencer 71. Specifically, in a case where the distance from the downstream end of the low-frequency silencer 71 to the outlet of the wind duct is defined as L, the high-frequency silencer 81 is disposed such that the distance from the downstream end of the high-frequency silencer 81 to the outlet of the wind duct is larger than L/2. The other points are under the same conditions between test 2 and test 1.

### (Test 3)

In test 3, the blowing source and the blowing destination (reverberation chamber) are directly connected by a Ty-Duct hose without using the low-frequency silencer 71 and the high-frequency silencer 81. The other points are under the same conditions between test 3 and test 1.

### (Measurement of Silencing Effect)

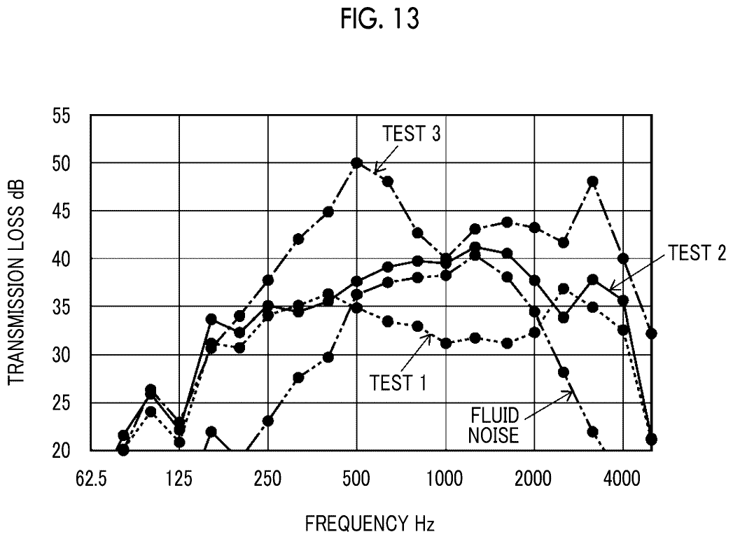

In each of tests 1 to 3, wind flows from the blower such that the wind speed in the Ty-Duct hose constituting the wind duct is 9.1 m/s. In addition, in each test, a noise spectrum indicating a noise amount at each frequency is acquired by measuring noise released from a terminal of the wind duct to the reverberation chamber with a microphone installed in the reverberation chamber. The measurement results are shown in FIG. 13. A horizontal axis of FIG. 13 indicates a center frequency (unit is Hz) of a ⅓-octave band, and a vertical axis indicates a noise amount (unit is dB).

In FIG. 13, a noise spectrum of the fluid noise generated in the wind duct under the above conditions is shown together with the above measurement results.

As can be seen from FIG. 13, in the configuration of test 2, fluid noise cannot be completely silenced, and the residual fluid noise propagates to the reverberation chamber. On the other hand, in the configuration of test 1, noise in the frequency band corresponding to the fluid noise is significantly reduced. To describe more specifically, in a frequency band (specifically, 800 Hz to 2,500 Hz) contributed by the fluid noise, in a case where the configuration of test 2 is adopted, a noise amount of the fluid noise in the reverberation chamber is 49.5 dB. On the other hand, in a case where the configuration of test 1 is adopted, the noise amount is 45.7 dB, and a difference from test 2 is-3.8 dB. From this, it is found that the silencing effect is significantly increased by securing an interval between the low-frequency silencer 71 and the high-frequency silencer 81 which is equal to or longer than a predetermined distance (specifically, L/2) and bringing the high-frequency silencer 81 closer to the outlet of the wind duct.

As described above, effects of the present invention are clear from the results of example 1 and test 1 described above.

### EXPLANATION OF REFERENCES

10: blowing source
12: wind duct
14: wind duct forming member
16: in-silencer wind duct
20: silencer
21: first silencer
22: second silencer
31: first housing
32: second housing
33, 35: tubular portion
33a, 35a: communication hole
33b: opening portion
34, 36: expansion portion
41: sound absorbing material
42: rear surface space
43: porous plate
60: measurement silencer
62: upstream wind duct
64: downstream wind duct
71: low-frequency silencer
72: tubular portion
72a: communication hole
73: expansion portion
74: sound absorbing material
81: high-frequency silencer
82: annular portion
83: expansion portion
84: sound absorbing material
100: wind duct with silencer
R: room
S: blowing system
W: wall
Z: reverberation chamber

What is claimed is:

1. A wind duct with a silencer comprising:
a wind duct in which wind sent from a blowing source flows; and
a first silencer and a second silencer that reduce sound propagating in the wind duct through a passive silencing method and that have frequency bands of sound to be reduced different from each other,
wherein the first silencer having a lower frequency band is disposed at a position closer to the blowing source,
the second silencer having a higher frequency band is disposed at a position farther away from the blowing source, and
among peak frequencies of generated sound in the wind duct caused by blowing in the wind duct, a frequency of a primary silencing peak of the second silencer is equal to or higher than a peak frequency at which an intensity of the generated sound is at its maximum.

2. The wind duct with a silencer according to claim 1,
wherein in a case where a distance from a downstream end of the first silencer to an outlet of the wind duct is defined as L, the second silencer is disposed at a position where a distance from a downstream end of the second silencer to the outlet of the wind duct is less than L/2.

3. The wind duct with a silencer according to claim 1,
wherein in a case where a size of a space surrounded by an outer wall surface of the first silencer is defined as a volume of the first silencer and a size of a space surrounded by an outer wall surface of the second silencer is defined as a volume of the second silencer, the volume of the second silencer is smaller than the volume of the first silencer.

4. The wind duct with a silencer according to claim 1,
wherein a minimum value of a diameter of the wind duct or a minimum value of a corresponding circular diameter of the wind duct is 150 mm or less.

5. The wind duct with a silencer according to claim 1,
wherein an in-silencer wind duct constituting a part of the wind duct is included inside each of a first housing provided in the first silencer and a second housing provided in the second silencer, and
at least one of the first housing or the second housing is entirely or partially formed of a resin material.

6. The wind duct with a silencer according to claim 1,
wherein a sound absorbing material formed of a resin material is disposed in at least one of the first silencer or the second silencer.

7. The wind duct with a silencer according to claim 1,
wherein at least one of the first silencer or the second silencer has an expansion portion,
the expansion portion has an inner space that has a cross section, which is orthogonal to an extending direction of the wind duct, larger than the wind duct, and
the inner space of the expansion portion includes an in-silencer wind duct constituting a part of the wind duct and a rear surface space positioned outside the in-silencer wind duct.

8. The wind duct with a silencer according to claim 1,
wherein the wind duct penetrates a wall separating two spaces, and
among the two spaces, the first silencer is disposed in one space, and the second silencer is disposed in the other space.

9. The wind duct with a silencer according to claim 8,
wherein the wall separates an inner space of a room accommodating a person and an outside of the room, and
a space where the second silencer is disposed is the inner space of the room.

10. The wind duct with a silencer according to claim 8,
wherein the second silencer is disposed at a position adjacent to the wall in the other space.

11. The wind duct with a silencer according to claim 1,
wherein an in-silencer wind duct constituting a part of the wind duct is included inside each of the first silencer and the second silencer, and
the in-silencer wind duct of the second silencer forms an end part of the wind duct on an outlet side.

12. The wind duct with a silencer according to claim 1,
wherein the wind duct is connected to an exhaust port of a fan that is the blowing source.

13. The wind duct with a silencer according to claim 2,
wherein in a case where a size of a space surrounded by an outer wall surface of the first silencer is defined as a volume of the first silencer and a size of a space surrounded by an outer wall surface of the second silencer is defined as a volume of the second silencer, the volume of the second silencer is smaller than the volume of the first silencer.

14. The wind duct with a silencer according to claim 2,
wherein a minimum value of a diameter of the wind duct or a minimum value of a corresponding circular diameter of the wind duct is 150 mm or less.

15. The wind duct with a silencer according to claim 2,
wherein an in-silencer wind duct constituting a part of the wind duct is included inside each of a first housing provided in the first silencer and a second housing provided in the second silencer, and
at least one of the first housing or the second housing is entirely or partially formed of a resin material.

16. The wind duct with a silencer according to claim 2,
wherein a sound absorbing material formed of a resin material is disposed in at least one of the first silencer or the second silencer.

17. The wind duct with a silencer according to claim 2,
wherein at least one of the first silencer or the second silencer has an expansion portion,
the expansion portion has an inner space that has a cross section, which is orthogonal to an extending direction of the wind duct, larger than the wind duct, and
the inner space of the expansion portion includes an in-silencer wind duct constituting a part of the wind duct and a rear surface space positioned outside the in-silencer wind duct.

18. The wind duct with a silencer according to claim 3,
wherein a minimum value of a diameter of the wind duct or a minimum value of a corresponding circular diameter of the wind duct is 150 mm or less.

19. The wind duct with a silencer according to claim 3,
wherein an in-silencer wind duct constituting a part of the wind duct is included inside each of a first housing provided in the first silencer and a second housing provided in the second silencer, and
at least one of the first housing or the second housing is entirely or partially formed of a resin material.

20. The wind duct with a silencer according to claim 3,
wherein a sound absorbing material formed of a resin material is disposed in at least one of the first silencer or the second silencer.
